(19) United States
(12) Patent Application Publication
(10) Pub. No.: US 2026/0253495 A1
(43) Pub. Date: Aug. 27, 2026

(54) Method for Informing a Cyclist of Potential Collisions, Traffic Networking Unit for a Bicycle, and Bicycle

(71) Applicant: Canyon Bicycles GmbH, Koblenz (DE)

(72) Inventor: Victor Fernando Casas Melo, Koblenz (DE)

(21) Appl. No.: 19/550,449

(22) Filed: Feb. 26, 2026

(30) Foreign Application Priority Data
Feb. 27, 2025 (DE) 102025107398.8

(51) Int. Cl. G08G 1/16; B62J 50/21; G08B 6/00; H04W 4/029; H04W 4/44; H04W 4/90

(52) U.S. Cl. CPC G08G 1/164; B62J 50/21; G08B 6/00; G08G 1/166; H04W 4/029; H04W 4/44; H04W 4/90

(57) ABSTRACT

A method for informing, in particular warning, a cyclist of potential collisions of the cyclist's bicycle with other road users, including the steps of detecting, in particular receiving, the position of at least one other road user, extrapolating a trajectory of at least one other road user on the basis of the detected position, extrapolating a trajectory of the bicycle, and emitting a signal to the cyclist if a probability of a collision between the bicycle and the at least one other road user, determined on the basis of the trajectories, exceeds a predefined risk threshold value. The invention also relates to a traffic networking unit and a bicycle.

### CROSS-REFERENCE TO RELATED APPLICATION

This application claims priority to German Patent Application No. 102025107398.8 filed February 27, 2025, the disclosure of which is hereby incorporated by reference in its entirety.

### BACKGROUND OF THE INVENTION

### FIELD OF THE INVENTION

The invention relates to a method for informing, in particular warning a cyclist of potential collisions, a traffic networking unit for a bicycle, a bicycle, as well as a system for data processing, a computer program and a computer-readable storage medium.

### DESCRIPTION OF RELATED ART

In road traffic, dangerous situations often arise between cyclists and other vehicles, especially at blind junctions, intersections or areas obscured by visual barriers. In such situations, road users do not have a clear view of each other, which increases the risk of collisions. Cyclists are particularly at risk as they are often directly involved in road traffic but have no crumple zone. They must rely primarily on the visible environment, although this is problematic in certain environments. For example, approaching vehicles may be obscured by buildings, trees, parked vehicles or other obstacles so that the cyclist does not see them in time.

The object of the invention is to protect cyclists, for example by means of a method and/or a device, from collisions with other road users, in particular to warn the cyclist of these collisions.

### SUMMARY OF THE INVENTION

According to the invention, the object is achieved by a method for informing and/or warning a cyclist of potential collisions, a traffic networking unit for a bicycle, a bicycle, a system for data processing, a computer program, and a computer-readable storage medium as described herein.

The invention relates to a method for informing, in particular warning, a cyclist of potential collisions of the cyclist's bicycle with other road users. The method comprises the step of detecting, in particular receiving, the position of at least one other road user, in particular in the vicinity of the bicycle. The position can preferably be detected relative to the bicycle and/or in absolute terms. A further step of the method consists of extrapolating a trajectory of at least one other road user, in particular the road user nearest to the bicycle, on the basis of the detected position. When the position of the at least one other road user is detected, a change in the position of the other road user is detected in particular. The detected position can include, for example, a speed, a direction of travel and/or an acceleration of the other road user, wherein, for example, an absolute value thereof or a change can be detected. A further step of the method consists of extrapolating a trajectory of the bicycle, in particular by means of a detected position, preferably a change in position of the bicycle. The method also comprises the step of emitting a signal, in particular an information and/or warning signal, to the cyclist if the probability of a collision, preferably a lateral collision, between the bicycle and the at least one other road user, as determined, in particular extrapolated, on the basis of the trajectories, exceeds a predefined risk threshold value. In particular, the trajectories are determined over a predefined, preferably future, time period y. Preferably, several risk thresholds can be exceeded, in particular an information threshold, e.g. for providing information to the cyclist, and a warning threshold, e.g. for issuing a warning to the cyclist.

It is preferred that the probability of the collision is determined on the basis of a predefined safety distance between the bicycle and the at least one other road user and in particular on the basis of distance in terms of time and/or distance until the safety distance is undershot, in particular by the bicycle. The safety distance between the bicycle and the at least one other road user is in particular a value that can be predefined or dynamic depending on the velocity vectors. The value can be adjusted, for example, based on the cyclist's experience and sense of safety. The safety distance is preferably a distance between the bicycle and a collision point. This value can be the normal stopping distance for the bicycle, e.g. given 1 second reaction time. The signal is preferably emitted when the bicycle and at least one other road user are on a collision course.

The trajectory of the bicycle and/or of the at least one other road user is, in particular, a predicted movement of the bicycle and of the other road user, respectively. The trajectory includes in particular the future position, preferably at the corresponding time. The trajectory is determined in particular on the basis of the position, speed, acceleration and/or direction of the bicycle and the other road user, respectively. Furthermore, the course of the road, detected obstacles and/or the traffic infrastructure can be taken into account to determine the trajectory.

It is preferred that the signal is a haptic feedback, preferably a vibration.

In particular, the haptic feedback is provided by the bicycle, preferably the handlebar of the bicycle. It is preferred that the haptic feedback is provided by at least one handle and/or in the handle area of the bicycle.

It is preferred that when the risk threshold value is exceeded due to the probability of a collision between the bicycle and another road user located to the left of the trajectory of the bicycle, haptic feedback is emitted from the left handle. Alternatively or additionally, when the risk threshold value is exceeded due to the probability of a collision between the bicycle and another road user located to the right of the trajectory of the bicycle, haptic feedback is emitted from the right handle. The road user located to the left or right of the trajectory is in particular a road user whose trajectory approaches the trajectory of the bicycle from the left or right, preferably intersecting the trajectory of the bicycle from the left or right.

It is preferred that at least one point of collision (POC) between the bicycle and the at least one other road user is determined, in particular extrapolated, using the trajectories. Preferably, this at least one POC is included in the determined probability of collision. A POC results in particular if the predefined safety distance between the bicycle and the at least one other road user is undershot, preferably on the trajectories and/or at a point in time. In particular, the method comprises the step of determining, e.g. calculating, the at least one POC using the trajectories of the bicycle and the at least one other road user.

It is preferred that the signal is emitted to the cyclist when the distance, in particular an extrapolated distance, to at least one POC, preferably the closest POC in terms of time and/or distance, falls below a first predefined limit value T₁. In particular, this emitted signal is an information signal. In particular, if said limit value T₁is undershot, the risk threshold value is exceeded by the probability of collision.

It is preferred that a signal with a higher intensity than the signal when falling below the first limit value T₁ is emitted to the cyclist when falling below a second predefined limit value T₂ of a, in particular extrapolated, distance in terms of time and/or distance to at least one, preferably the closest POC in terms of time and/or distance. This emitted signal is a warning signal in particular, which has a higher intensity than the information signal. The second limit value T₂is in particular smaller than the first limit value T₁, e.g. by at least 10%, preferably by at least 20%, particularly preferably by at least 30%.

It is preferred that when the position of the at least one other road user is detected, this position is received, preferably by the at least one other road user. It is preferred that the position of the at least one other road user is detected by means of a V2X system, preferably on the bicycle, particularly preferably integrated into the bicycle. Preferably, the position of the at least one other road user is received by means of the V2X system.

It is preferred that the bicycle, preferably the V2X system, transmits the position, in particular the changing position, to other road users. In particular, the bicycle receives and/or transmits CAM (cooperative awareness messages), VAM (VRU awareness message), and/or similar cooperative messages, preferably by means of the V2X system. Transmission and/or reception takes place in particular by means of a V2X antenna, e.g. arranged on the bicycle. The V2X antenna is preferably an antenna with dedicated short-range communication (DSRC) technology, e.g. in accordance with IEEE 802.11 ITS-G5/ ITS-G5 Rel.2, C-V2X/LTE-V2X and/or 5G-NR V2X. The V2X antenna preferably has a range of 100 m to 1000 m, preferably 300 m to 600 m. For example, the V2X antenna can also be a V2X antenna for the frequency defined in the standard.

Preferably, the method comprises the step of detecting the position, in particular the change in position, of the bicycle, for example by means of at least one GNSS antenna arranged on the bicycle. Instead of or in addition to detecting the position of the bicycle using a GNSS antenna, the position of the bicycle can also be detected using at least one sensor, e.g. an acceleration sensor. The detected position of the bicycle is preferably used to extrapolate the trajectory of the bicycle. The position of the at least one road user is preferably determined by means of at least one GNSS antenna attached to this road user. Preferably, the positions of the bicycle and/or the at least one road user are transmitted by means of a standardized message, e.g. CAM and/or equivalent message type. The method preferably comprises the step of checking whether the detected position of the bicycle is older than a predetermined time t. If it is determined that the position is older than t, a new position of the bicycle is determined. Furthermore, the method comprises in particular a check as to whether positions of at least one other road user have been detected, preferably received, within a predefined time interval q. In doing so, the method preferably comprises a CAM queue. If no positions were detected within q, in particular if no CAM was received, preferably no signal is emitted and/or no extrapolation of the trajectory of the bicycle and/or of the at least one other road user takes place.

The invention further relates to a system for data processing, comprising means for carrying out the method according to the invention.

The invention further relates a computer program comprising instructions which, when the program is executed by a computer, cause the computer to perform the method according to the invention.

The invention further relates to a computer-readable storage medium, wherein the storage medium comprises instructions which, when executed by a computer, cause the computer to perform the method according to the invention, and/or the computer program according to the invention is stored on the storage medium.

The invention also relates to a traffic networking unit, in particular a V2X unit, for a bicycle. The traffic networking unit comprises a communication system for transmitting the position of the bicycle to other road users and for receiving the position of other road users. Furthermore, the traffic networking unit comprises a feedback device to be arranged on the bicycle for providing haptic feedback to the cyclist of the bicycle based on the received position. The feedback to be emitted is a vibration in particular. The traffic networking unit, preferably a control unit of the traffic networking unit, is configured in particular to carry out the method according to the invention.

It is preferred that the feedback device is configured to provide the haptic feedback to the cyclist via a handlebar of the bicycle, in particular at least one handle or both handles of the handlebar. Preferably, the feedback device is configured to be integrated into the handlebar, in particular to be arranged inside the handlebar tube.

It is preferred that the feedback device is configured to provide feedback to the cyclist independently of one another via a right and a left handle and/or in the right and handle areas of the bicycle, in particular the handlebar. For example, the vibration actuator can be connected to an end cap of the handle. For example, the vibration actuator can be arranged on the end cap in such a way that it can be pushed into the handlebar together with the end cap. In particular, the end cap can be used as a mount for the vibration actuator in the handlebar. Alternatively or additionally, the vibration actuator can be connected to a clamp of the handle, in particular it can be integrated into the clamp.

It is preferred that the feedback device is configured to provide feedback of varying intensity, in particular varying intensity per handle.

It is preferred that the traffic networking unit, in particular the communication system, has a positioning antenna, in particular a GNSS antenna, to be arranged on the bicycle to determine the position of the bicycle; and/or that the traffic networking unit, in particular the communication system, has a vehicle communication antenna, in particular a V2X antenna, to be arranged on the bicycle to communicate with other road users.

It is preferred that the positioning antenna and/or the vehicle communication antenna is adapted to be arranged on a head tube of the bicycle, in particular that it is adapted to be integrated into the head tube.

In particular, the antennas can be placed on the head tube and/or integrated in the head tube, e.g. through a window. The V2X antenna is preferably positioned freely upwards and/or above the GNSS antenna. This ensures in particular that the GNSS antenna has a clear view of the sky for the GNSS and/or that the GNSS antenna is not shadowed by the cyclist. In particular, the window is designed to meet the structural requirements of the head tube and/or additional components can be added. The arrangement on the head tube ensures stable positioning in particular, as the head tube is not as flexible as handlebar or fork, for example. This measure improves the reception of signals from the satellites, the direction of travel of the bicycle can be determined more accurately, and the preferred use of acceleration sensors to improve the GNSS modules is more effective. Preferably, the angle of the GNSS antenna can be adjusted, in particular separately from the V2X antenna, in order to optimize the view of the sky. As the bicycle usually travels forwards, potential hazards are relevant to the direction of travel. The selected position for the V2X antenna enables maximum range and/or detectability in the direction of travel.

It is preferred that the traffic networking unit has a control unit, in particular a V2X module, which is adapted to be integrated into a bicycle frame of the bicycle. In particular, the control unit has or consists of the data processing system according to the invention. In particular, the control unit is configured to determine the trajectories, transmit and receive signals by means of the antennas and/or control the feedback device.

The invention further comprises a bicycle with a traffic networking unit according to the invention, in particular for warning a cyclist of the bicycle of potential collisions with other road users.

It is preferred that the communication system is integrated into the bicycle, in particular a bicycle frame of the bicycle. Preferably, one, several or all components of the communication system, e.g. the positioning antenna and/or the vehicle communication antenna, and in particular the control unit are integrated into the bicycle frame, e.g. integrated into one or more frame tubes, such as the top tube and/or the down tube.

It is preferred that the feedback device is integrated into the handlebar and/or one or both handles of the bicycle. Preferably, the feedback device is located inside the handlebar tube and/or in one or both handles. In particular, the feedback device has at least one vibration actuator, which is preferably integrated accordingly.

Preferably, the communication system, in particular the positioning antenna and/or the vehicle communication antenna, is arranged on a head tube of the bicycle, in particular integrated into the head tube. Preferably, the positioning antenna and/or the vehicle communication antenna is arranged in the head tube, in particular behind a preferably covered, e.g. glazed, window of the head tube. The control unit, in particular the V2X module, is preferably integrated into the bicycle frame. Preferably, the control unit is arranged inside a bicycle tube, e.g. the down tube or the top tube. The control unit is preferably connected to a battery, preferably of the bicycle, in particular in the e-bike version of the bicycle, for power supply. Preferably, the closed down tube has an opening, in particular only one opening, for the installation of a battery. The V2X module and the battery are installed and secured in the down tube through the opening. The battery can be permanently installed or removable, in particular by means of a lock. Preferably, the top tube is closed and only accessible through the head tube when the fork and handlebar are not installed. In the preferred embodiment, where the top tube has a display, it is preferable for the V2X module to be integrated in the top tube in front of the display. This measure and/or the general arrangement in the top tube has the advantage that the accessibility of the V2X module is limited. This prevents manipulation, in particular undesired interference with road traffic. In particular, the V2X module is connected to the antennas, preferably by internally routed cables. Preferably, both antennas are located in the head tube. The GNSS antenna is preferably positioned under the V2X antenna to extend the distance to the handlebar. This reduces the shadowing from the handlebar on the GNSS antenna. The V2X module is preferably connected to the feedback device, in particular by means of at least one internally routed cable.

Furthermore, the control unit can in particular have a system to detect its connection to a specific bicycle, in particular a specific bicycle frame. For example, the system can read a tag, e.g. NFC tag, embedded and/or glued in the frame. In particular, the tag is a passive element with information for identifying the bicycle and/or the bicycle frame. The information is preferably encrypted and can only be read and decrypted by the control unit. If, for example, the control unit is removed from the specific bicycle, it no longer sends messages to other road users. This is to ensure that the V2X system, which indicates the presence of a bicycle, can be perceived as reliable by other road users.

It is preferred that one or more objects according to the invention, i.e. the method, the traffic networking unit, the bicycle, the system for data processing, the computer program and/or the computer-readable storage medium, each have one or more features of the other objects according to the invention.

### BRIEF DESCRIPTION OF THE DRAWINGS

In the following, the invention is described in more detail by means of preferred embodiments with reference to the accompanying drawings.

The terms Fig., Figs., Figure, and Figures are used interchangeably in the specification to refer to the corresponding figures in the drawings.

### In the Figures

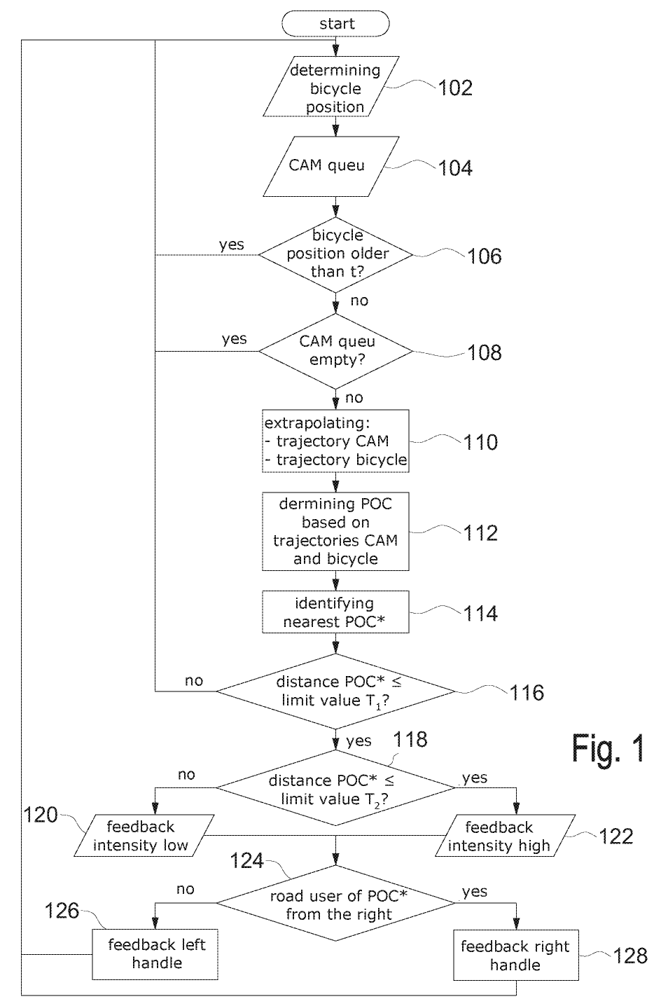

FIG. 1 shows a flow diagram illustrating an embodiment according to the invention of a method according to the invention,

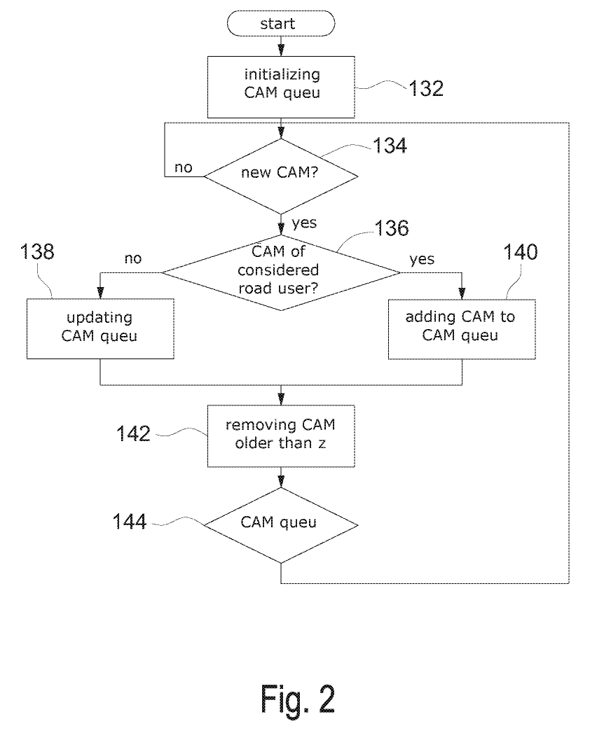

FIG. 2 shows a flow chart illustrating a preferred sub-process in the method according to FIG. 1,

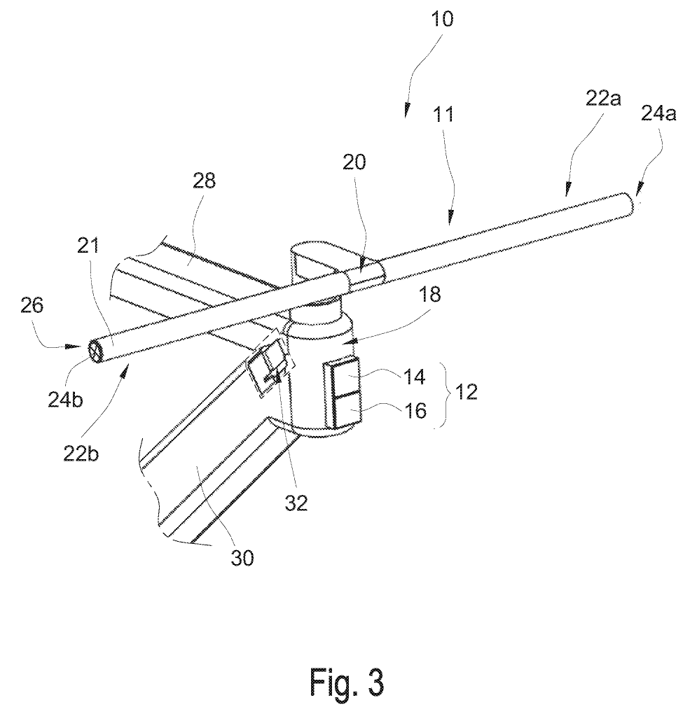

FIG. 3 shows a schematic illustration of a part of an embodiment of a bicycle according to the invention with an embodiment of a traffic networking unit according to the invention,

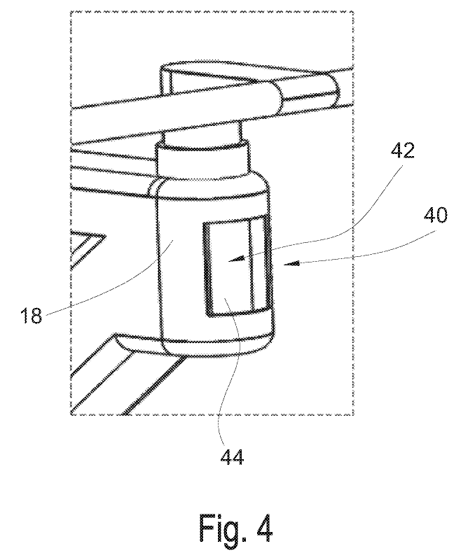

FIG. 4 shows a partial section of the head tube of the bicycle from FIG. 3 in an alternative configuration,

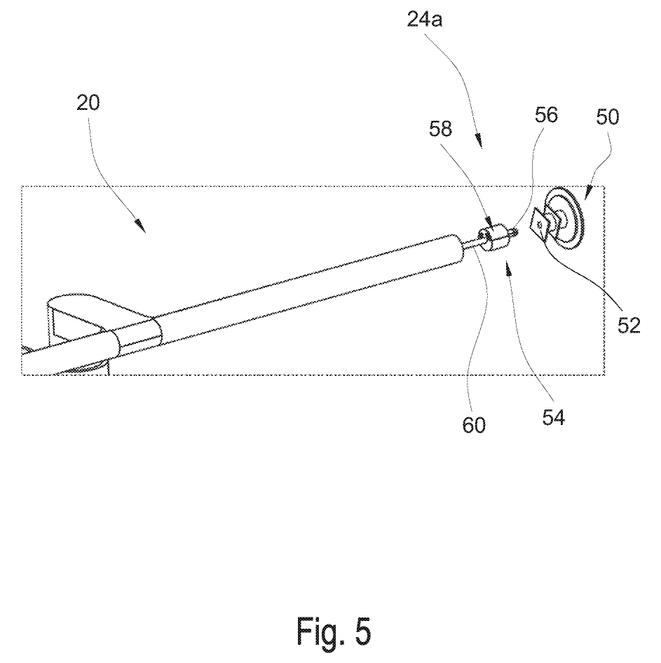

FIG. 5 shows a partial section of the handlebar from FIG. 3 with a preferred, alternative configuration of the vibration actuator, and

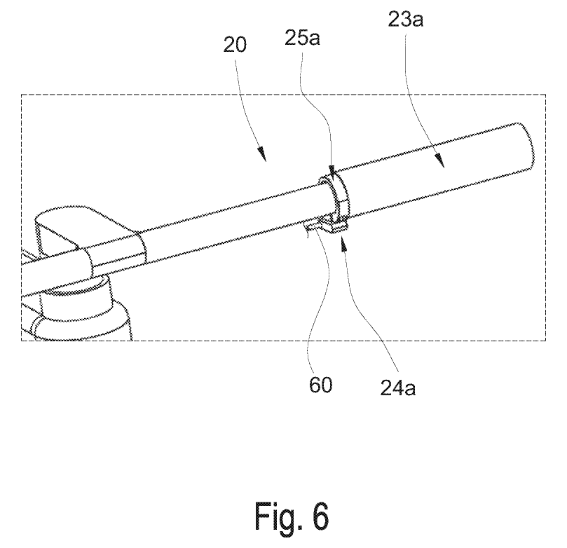

FIG. 6 shows a partial section of the handlebar from FIG. 3 with a further preferred, alternative configuration of the vibration actuator.

### DESCRIPTION OF THE INVENTION

FIG. 1 shows a flow diagram of an embodiment of the method according to the invention for informing and/or warning a cyclist of potential collisions.

First, the position of the bicycle 10 of the cyclist to be warned is determined – step 102. This determination can be carried out, for example, by means of a GNSS antenna 14 (see FIG. 3) arranged on the bicycle 10. Then, the position of at least one other road user is received. For this purpose, a CAM queue is determined – step 104. A preferred procedure for determining the CAM queue (step 104) is shown in FIG. 2. The CAM queue contains position information of the at least one other road user, in the form of CAMs (cooperative awareness messages) and/or equivalent messages, e.g. VAM, DENM, etc. The CAMs are received in particular by means of a V2X antenna 12 arranged on the bicycle 10 (see FIG. 3).

This is followed by a query as to whether the determined bicycle position is older than a predetermined time t – step 106. If this is the case ("yes"), the method is continued at step 102. In particular, this checks that the bicycle's position data is up-to-date and preferably also correct.

If the bicycle position is not older than t ("no"), a query is made as to whether the CAM queue is empty, i.e. in particular whether no CAM has been received and/or the received CAM has been sorted out (see FIG. 2, step 142) – step 108. If the queue is empty ("yes"), the method is continued at step 102.

If the queue is not empty ("no"), a trajectory of the bicycle 10 is extrapolated based on the detected position of the bicycle and a trajectory of the at least one other road user is extrapolated based on the CAM of the queue – step 110. This extrapolation is carried out in particular for a predetermined time period y.

The trajectories are then used to determine, in particular extrapolate, at least one point of collision (POC) between the bicycle 10 and the at least one other road user – step 112. The closest POC* to the bicycle in terms of time and/or distance is identified – step 114.

This is followed by a query as to whether the distance of the bicycle to the POC* in terms of time and/or distance isless than or equal to a predefined limit value T₁ – step 116. If this is not the case ("no"), it is concluded that the probability of a collision does not exist or is sufficiently low. The method is then continued at step 102.

If the distance of the bicycle to the POC* > T₁in terms of time and/or distance ("yes"), the query is made as to whether the distance of the bicycle to the POC*isless than or equal to a predefined limit value T₂ in terms of time and/or distance – step 118. In particular, the following applies: T₁<< T₂.

If this is not the case ("no"), a feedback, in particular a vibration, provided to the cyclist is set at a low intensity – step 120. In particular, this indicates a moderate probability of collision or information that another road user is likely to intersect the trajectory of the bicycle. If the distance of the bicycle to the POC* > T₂in terms of time and/or distance, a feedback, in particular a vibration, provided to the cyclist is set at a high intensity – step 122. In particular, this indicates a high probability of collision. Preferably the following applies: low intensity << high intensity.

This is followed by a query as to whether the POC* is caused by a road user approaching from the right, in particular whether the trajectory of the other road user intersects the trajectory of the bicycle from the right. If this is the case ("yes"), the corresponding feedback is provided in low or high intensity by the right handle 22b of the bicycle 10 (see FIG. 3). If this is not the case ("no"), the corresponding feedback is provided by the left handle 22a of the bicycle 10.

If several POC* are identified, the closest POC* in terms of time and/or distance and the road user causing it are used to generate the feedback.

The step 102 of FIG. 1, i.e. the determination of the CAM queue, is formed in particular by the preferred sub-process according to FIG. 2.

First, the CAM queue is initialized – step 132. Here, CAMs are received in particular.

This is followed by a query as to whether at least one new CAM has been received – step 134.

If this is the case ("yes"), a query is made as to whether this CAM originates from the other road user already under consideration – step 136. If this is the case ("yes"), the CAM is added to the CAM queue – step 140. Otherwise ("no"), the CAM queue is updated – step 138.

CAMs that are older than a predefined time interval z, especially in seconds, are then removed from the CAM queue – step 142. In particular, this checks that the CAM data is up-to-date and preferably also correct.

The resulting CAM queue (step 144) corresponds in particular to the CAM queue according to step 104 of FIG. 1.

FIG. 3 shows a preferred embodiment of a bicycle 10 according to the invention with an embodiment of a traffic networking unit 11 according to the invention.

The bicycle 10 has a top tube 28 and a down tube 30, which are only partially shown. Furthermore, the bicycle has a handlebar tube 18 connected to the top tube 28 and the down tube 30, which accommodates a handlebar 20.

A communication system 12 with a positioning antenna 16, in particular a GNSS antenna, and a vehicle communication antenna 14, in particular a V2X antenna, is arranged on the head tube 18. The angle of the positioning antenna 16 can be adjusted in particular.

A control unit 32, which in particular comprises or consists of a V2X module, is arranged inside the down tube 30 (a partial section of the inside of the down tube 30 is shown for illustration purposes).

A feedback device 26 is provided within the handlebar 20, in particular housed in the handlebar tube 21. The feedback device 26 has a vibration actuator 24a, 24b (shown schematically) on each handle side 22a, 22b for providing haptic feedback to the cyclist. The handlebar 20 is shown without separate bicycle handles. In a preferred alternative embodiment, the handlebar 20 may in particular comprise a right handle in the right handle area 24b and a left handle in the left handle area 24a, wherein it is then preferred that the haptic feedback of the vibration actuators 24a, 24b is provided to the cyclist via the handlebar 20 and the respective handles.

Preferably, the control unit 32 is configured to determine the trajectories, transmit and receive signals by means of the antennas 14, 16 and/or control the feedback device 26. It is preferred that the control unit is connected to the antennas 14, 16 and/or the feedback device 26 by means of cables, in particular internal cables (not shown). The control unit 32 is in particular configured to carry out the method according to the invention, for example the method according to FIG. 1, supplemented in particular by FIG. 2.

FIG. 4 shows a preferred alternative embodiment of the head tube 18 as shown in FIG. 3. The head tube 18 has an opening 40 to the inside 42 of the head tube 18. The positioning antenna 14 and/or the vehicle communication antenna 16 is preferably arranged in the opening 40, i.e. in the interior 42 of the head tube 18 (not shown). The opening is preferably covered by a glazed window, for example. Instead of the embodiment shown in FIG. 4, an embodiment according to FIG. 4 is also possible in which the opening 40 is not provided.

The method according to FIG. 1, in particular supplemented by FIG. 2, is preferably carried out with a bicycle 10 and/or a traffic networking unit 11 according to FIG. 3 or FIG. 4.

FIG. 5 shows a partial section (on the left side) of the bicycle handlebar 20 of FIG. 3 with a preferred, alternative embodiment of the vibration actuator 24a.

The vibration actuator 24a has a housing 54 in which a vibration motor 58 (not shown) is arranged to emit the vibration. A cable 60 routed inside the handlebar 20 is connected to the vibration actuator 24a for power and/or data transmission.

A connecting pin 56, e.g. in one piece, is connected to the housing 54 for fixing and in particular for mounting. The connecting pin 56 can be received in a fixing manner, in particular in a detachably fixing manner, in a receptacle 52 of the end cap 50 of the handlebar 20. The vibration actuator 24a can thus be arranged in a fixed position within the handlebar and mounted together with the end cap 50. The opposite right-hand side of the handlebar 20 preferably has a corresponding vibration actuator 24b.

FIG. 6 also shows a partial section (on the left side) of the bicycle handlebar 20 of FIG. 3 with further a preferred, alternative embodiment of the vibration actuator 24a. The vibration actuator 24a is connected to the handle clamp 25a of the left handle 23a, in particular it is integrated with the handle clamp 25a.

1. A method for informing, in particular warning a cyclist of potential collisions with other road users, comprising the steps:
detecting the position of at least one other road user,
extrapolating a trajectory of at least one other road user on the basis of the detected position,
extrapolating a trajectory of a bicycle of the cyclist, and
emitting a signal to the cyclist if a probability of a collision between the bicycle and the at least one other road user, determined on the basis of the trajectories, exceeds a predefined risk threshold value.

2. The method according to claim 1, wherein the signal is a haptic feedback.

3. The method according to claim 2, wherein the haptic feedback is provided by at least one handle area of the bicycle.

4. The method according to claim 3, wherein
when the risk threshold value is exceeded due to the probability of a collision between the bicycle and another road user located to the left of the trajectory of the bicycle, haptic feedback is emitted from the left side of the handlebar, in particular the left handle, and/or
when the risk threshold value is exceeded due to the probability of a collision between the bicycle and another road user located to the right of the trajectory of the bicycle, haptic feedback is emitted from the left right of the handlebar, in particular the right handle.

5. The method according to claim 1, wherein at least one collision point POC between the bicycle and the at least one other road user is determined on the basis of the trajectories.

6. The method according to claim 5, wherein the signal is emitted to the cyclist when the distance to at least one POC falls below a first predefined limit value in terms of time and/or distance.

7. The method according to claim 6, wherein when the distance to at least one POC falls below a second predefined limit value in terms of time and/or distance, a signal is emitted to the cyclist with a higher intensity than the warning signal when the distance falls below the first limit value.

8. The method according to claim 1, wherein the position of the at least one other road user is detected by means of a V2X system.

9. A system for data processing, comprising means for carrying out the method according to claim 1.

10. A computer program product comprising instructions which, when the program is executed by a computer, cause the computer to perform the method according to claim 1.

11. A computer-readable storage medium, wherein the storage medium comprises instructions which, when executed by a computer, cause the computer to perform the method according to claim 1.

12. A traffic networking unit, in particular a V2X unit, for a bicycle, comprising
a communication system for transmitting the position of the bicycle to other road users and for receiving the position of other road users,
a feedback device to be arranged on the bicycle for providing haptic feedback to the cyclist of the bicycle based on the received position.

13. The traffic networking unit according to claim 12, wherein the feedback device is configured to provide the haptic feedback to the cyclist via a handlebar of the bicycle.

14. The traffic networking unit according to claim 12, wherein the feedback device is configured to provide feedback to the cyclist independently of one another via a right and a left handle area, in particular handle, of the bicycle.

15. The traffic networking unit according to claim 12, wherein the feedback device is configured to provide feedback at different intensities.

16. The traffic networking unit according to claim 12, wherein the traffic networking unit has a positioning antenna, in particular a GNSS antenna, to be arranged on the bicycle for determining the position of the bicycle; and/or in that the traffic networking unit has a vehicle communication antenna, in particular a V2X antenna, to be arranged on the bicycle for communication with other road users.

17. The traffic networking unit according to claim 16, wherein the positioning antenna and/or the vehicle communication antenna is adapted to be arranged on a head tube of the bicycle, in particular is adapted to be integrated into the head tube.

18. The traffic networking unit according to claim 17, wherein the traffic networking unit has a control unit, for example a V2X module, which is adapted to be integrated in particular into a bicycle frame of the bicycle.

19. A bicycle comprising a traffic networking unit according to claim 12.

20. The bicycle according to claim 19, wherein the feedback device is integrated into a handlebar and/or one or both handles of the bicycle.
